(19) United States
(12) Patent Application Publication
(10) Pub. No.: US 2016/0217206 A1
(43) Pub. Date: Jul. 28, 2016

(54) CONVERSATION PROCESSING METHOD, CONVERSATION PROCESSING SYSTEM, ELECTRONIC DEVICE, AND CONVERSATION PROCESSING APPARATUS

(71) Applicant: Panasonic Intellectual Property Management Co., Ltd., Osaka (JP)

(72) Inventor: Takashi MUKAIYAMA, Osaka (JP)

(21) Appl. No.: 14/982,572

(22) Filed: Dec. 29, 2015

(30) Foreign Application Priority Data
Jan. 26, 2015 (JP) 2015-011967
Dec. 7, 2015 (JP) 2015-238162

(51) Int. Cl. G06F 17/30

(52) U.S. Cl. CPC G06F 17/30684; G06F 17/30867

(57) ABSTRACT

A method executed in an interactive application with which a user interacts on an electronic device includes: selecting, in a topic table storing a plurality of sets of topic information and a weight of the topic information, the topic information based on the weight and presenting the topic information to the user; storing a conversation history which associates with the topic information, time, an answer of the user to the selected topic information and answer date and time, in a conversation history table; calculating a use rate of a use time of the interactive application relative to a use time of the device based on the conversation history table; and notifying of encouraging use of the interactive application when the use rate is decreased, and updating the weight of the topic information without the answer of the user in the conversation history table when the use rate is not decreased.

### BACKGROUND OF THE INVENTION

1. Field of the Invention

The present disclosure relates to a conversation processing method, a conversation processing system, and an electronic device, for interacting continuously with a user.

2. Description of the Related Art

Patent Literature 1 relates to a conversation processing apparatus, a conversation processing method, and a recording medium, and particularly discloses a conversation processing apparatus, a conversation processing method, and a recording medium, which are suitable for a robot interacting with a user. Specifically, in order to interact with a user naturally, a time until a user's answer to a question from the robot is measured, and whether to transit a topic or not is determined based on the measured time.

Patent Literature 2 relates to a robot controlling apparatus, and discloses a robot controlling apparatus allowing suitable communication (a chat type dialogue) between, for example, a partner type robot and an elderly person. Specifically, the apparatus calculates an evaluation value for each topic in consideration of a relation between a present time and a time point on a time series suitable for a topic. The apparatus selects an appropriate topic based on the magnitude of the evaluation value, and outputs sentences corresponding to the topic by voice.

### CITATION LIST

### Patent Literatures

PTL 1: Unexamined Japanese Patent Publication No. 2001-188786

PTL 2: Unexamined Japanese Patent Publication No. 2008-158697

### SUMMARY OF THE INVENTION

The present disclosure provides a conversation processing method, a conversation processing system, an electronic device, and a conversation processing apparatus, for interacting continuously with a user.

The conversation processing method of the present disclosure is a conversation processing method executed in an interactive application with which a user interacts, on an electronic device, the method including: selecting, in a topic table storing a plurality of sets of topic information and a weight of the topic information, the topic information based on the weight and presenting the selected topic information to the user; storing a conversation history which associates with the selected topic information, presentation date and time, an answer of the user to the selected topic information and answer date and time, in a conversation history table; calculating a use rate of a use time of the interactive application relative to a use time of the electronic device based on the conversation history table; and notifying of encouraging use of the interactive application when the use rate is decreased, and updating the weight of the topic information without the answer of the user in the conversation history table when the use rate is not decreased

The conversation processing method, the conversation processing system, the electronic device, and the conversation processing apparatus of the present disclosure enable to interact continuously with the user.

### BRIEF DESCRIPTION OF DRAWINGS

FIG. 1 is a block diagram of a conversation processing system according to a first exemplary embodiment;

FIG. 2 is a diagram showing an example of a topic table according to the first exemplary embodiment;

FIG. 3 is a diagram showing an example of a conversation history table according to the first exemplary embodiment;

FIG. 4 is a diagram showing an example of a use rate table according to the first exemplary embodiment;

FIG. 5 is a diagram showing an example of a use time table according to the first exemplary embodiment;

FIG. 6 is a time chart for describing conversation processes of the conversation processing system according to the first exemplary embodiment;

FIG. 7A is a diagram showing another example of the conversation history table according to the first exemplary embodiment;

FIG. 7B is a diagram showing still another example of the conversation history table according to the first exemplary embodiment;

FIG. 8 is a diagram showing an example of displaying a topic on a client according to the first exemplary embodiment;

FIG. 9 is a flowchart for updating a weight in the topic table according to the first exemplary embodiment;

FIG. 10 is a diagram showing an example of displaying a message encouraging conversation on the client according to the first exemplary embodiment; and

FIG. 11 is a diagram showing another example of the topic table according to the first exemplary embodiment.

### DETAILED DESCRIPTION OF THE PREFERRED EMBODIMENT

In the following, with reference to the drawings as appropriate, a detailed description will be given of an exemplary embodiment. However, an unnecessarily detailed description may be omitted. For example, a detailed description of an already well known matter or a repetitive description of substantially identical configurations may be omitted. This is to avoid the following description from becoming unnecessarily redundant, and to facilitate understanding of a person skilled in the art.

Note that, the accompanying drawings and the following description are provided in order for a person skilled in the art to fully understand the present disclosure, and they are not intended to limit the subject matter stated in the scope of claims.

### First Exemplary Embodiment

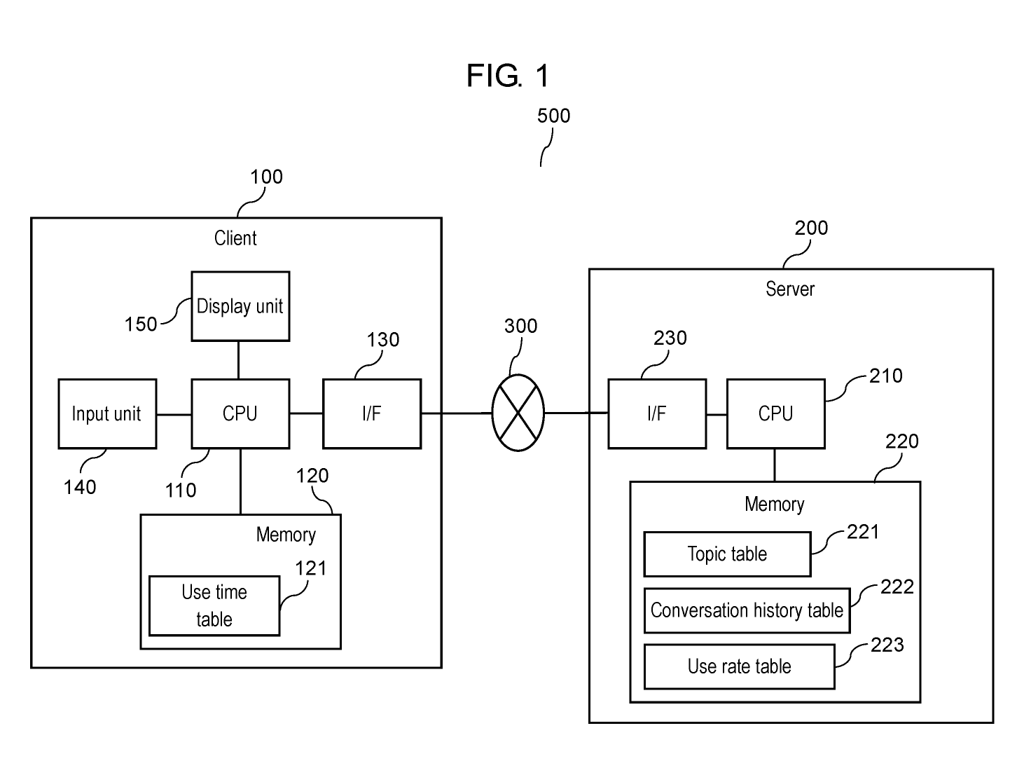

In the following, with reference to FIGS. 1 to 11, a description will be given of a first exemplary embodiment.

### [1-1. Configuration]

### [1-1-1. Configuration of System]

Firstly, a configuration of a conversation processing system will be described. FIG. 1 is a block diagram of conversation processing system 500 according to the first exemplary embodiment. FIG. 1 shows a functional configuration where conversation processing system 500 is implemented by client-server model. In conversation processing system 500, client 100 connects to server 200 via communication network 300 being an internet connection network. Client 100 is an electronic device, for example, such as a smartphone or a tablet-type device. In client 100, an interactive application is installed.

Server 200 stores therein a plurality of pieces of topic information used in conversation with the user. The topic information is information indicating the content of a topic and answer candidates. The topic information will be described later. Server 200 selects a piece of topic information among a plurality of pieces of topic information, and transmits the selected topic information to client 100. Client 100 presents the received topic information to the user. Client 100 transmits, to server 200, an answer input by the user in response to the presented topic. Server 200 registers the received answer as a conversation history, and selects next topic information.

In this manner, conversation processing system 500 continues conversation with the user, by repeating selection of topic information and registration of the conversation history in server 200, and presentation of the topic information and input of the answer in client 100.

### [1-1-2. Configuration of Server]

Next, a configuration of server 200 will be described. As shown in FIG. 1, server 200 includes Central Processing Unit (CPU) 210, memory 220, and communication Interface (I/F) 230.

Memory 220 includes topic table 221, conversation history table 222, and use rate table 223.

Topic table 221 stores a plurality of pieces of topic information presented to the user. Note that, topic table 221 may be provided for each user, such that conversation is suitable for each user.

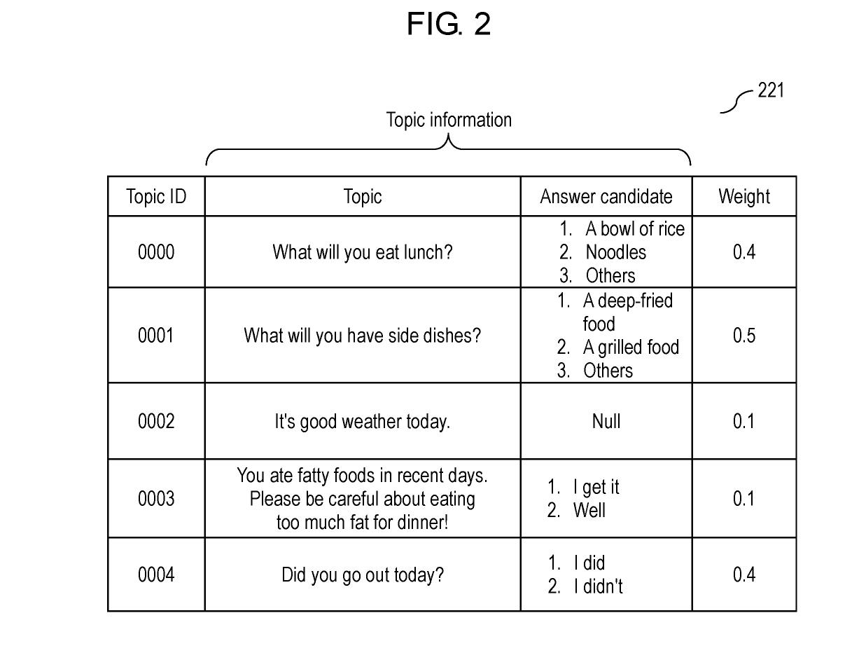

FIG. 2 is a diagram showing an example of topic table 221. Topic table 221 is constructed that each conversation ID associates with a topic, which indicates topic information, answer candidates, and a weight. The conversation ID is identification information for specifying topic information. The weight shows a degree of priority for selecting a topic. A topic is selected in order of the weights or according to the probability proportional to the weights. As the weights, for example numerical values falling within a range “from 0 to 1” are set.

As shown in FIG. 2, a conversation ID “0000” stores three answer candidates “1. A bowl of rice, 2. Noodles, 3. Others” and a weight “0.4” to a topic “What will you eat lunch?”. Subsequently, a conversation ID “0001” stores three answer candidates “1. A deep-fried food, 2. A grilled food, 3. Others” and a weight “0.5” to a topic “What will you have side dishes?”. A conversation ID “0002” stores answer candidates “Null” indicating that there are no answer candidates and a weight “0.1” and to a topic “It's good weather today.”. Since the topic “It's good weather today.” does not require a response, an answer candidate is “Null”. A conversation ID “0003” stores two answer candidates “1. I get it, 2. Well” and a weight “0.1” to a topic “You ate fatty foods in recent days. Please be careful about eating too much fat for dinner!”. A conversation ID “0004” stores two answer candidates “1. I did, 2. I didn't.” and a weight “0.4” to a topic “Did you go out today?”.

Note that, although topic table 221 is constructed by four items, other items may be additionally defined. For example, a condition of selecting a topic may be added, such as, the conversation ID “0001” is always selected after presentation of the conversation ID “0000”. As the condition of additionally selecting a topic, a result of answer, date and time, or user attributes may be used. Further, as the condition of selecting a topic, a maximum number of selections per day may be defined, such as, the conversation ID “0000” is selected up to once a day.

Returning back to the description of FIG. 1, conversation history table 222 of memory 220 stores the conversation history. The conversation history may be managed for each user, and conversation history table 222 may be provided for each user.

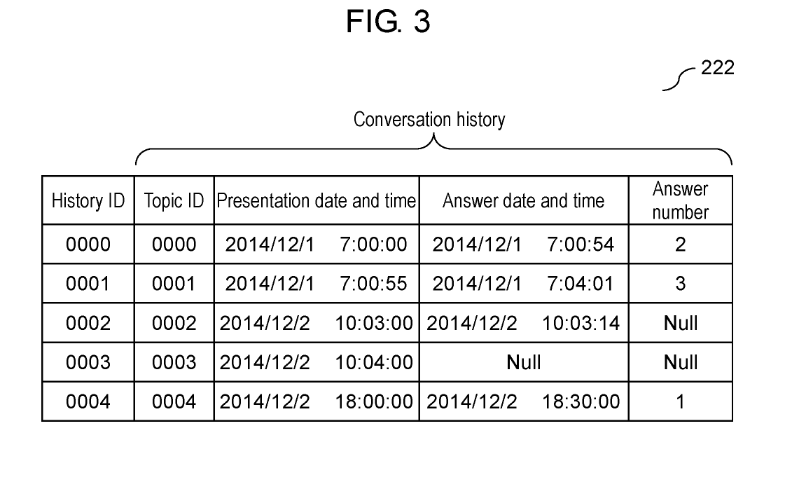

FIG. 3 is a diagram showing an example of conversation history table 222. As shown in FIG. 3, conversation history table 222 is constructed by history ID and the conversation history. The conversation history is constructed by the conversation ID, the presentation date and time, the answer date and time, and answer number. The presentation date and time indicates the date and time when server 200 has transmitted topic information to client 100. The answer date and time indicates the date and time when user has answered to a topic. The answer number indicates the number of the answer selected by the user among answer candidates. Further, with respect to a topic without answer candidates, the answer date and time is the date when the user has read the topic, and the answer number is Null or the like. In FIG. 3, the history ID “0000” is associated with the conversation ID “0000”, the presentation date and time “2014/12/1 7:00:00”, the answer date and time “2014/12/1 7:00:54”, and the answer number “2”; the history ID “0001” is associated with the conversation ID “0001”, the presentation date and time “2014/12/1 7:00:55”, the answer date and time “2014/12/1 7:04:01”, and the answer number “3”; the history ID “0002” is associated with the conversation ID “0002”, the presentation date and time “2014/12/2 10:03:00”, the answer date and time “2014/12/2 10:03:14”, and the answer number “Null”; the history ID “0003” is associated with the conversation ID “0003”, the presentation date and time “2014/12/2 10:04:00”, the answer date and time “Null”, and the answer number “Null”; the history ID “0004” is associated with the conversation ID “0004”, the presentation date and time “2014/12/2 18:00:00”, the answer date and time “2014/12/2 18:30:00”, and the answer number “1”.

Note that, in conversation history table 222 shown in FIG. 3, although the conversation history is constructed by four items, other items may be additionally defined.

Returning back to the description of FIG. 1, use rate table 223 of memory 220 stores the rate of the use time of the interactive application relative to the use time of client 100 by the user. Specifically, a proportion of the use time of the interactive application relative to the use time of client 100 by the user is stored as the use rate on a daily basis. In the present disclosure, the use rate is used as willingness of the user to use the interactive application. Practically, the use time of client 100 varies in accordance with the schedule of the user for each day, and therefore the use time of the interactive application varies irrespective of willingness of the user using the interactive application. In the present disclosure, considering this, the use rate is obtained by dividing the use time of the interactive application by the use time of client 100 of the user, and the use rate is used as the use willingness for the interactive application. In the present disclosure, use rate table 223 is provided for each user. Note that, the use rate of a plurality of users may be managed with a single use rate table. In this case, ID, which uniquely identifies the user, should be defined in the use rate table.

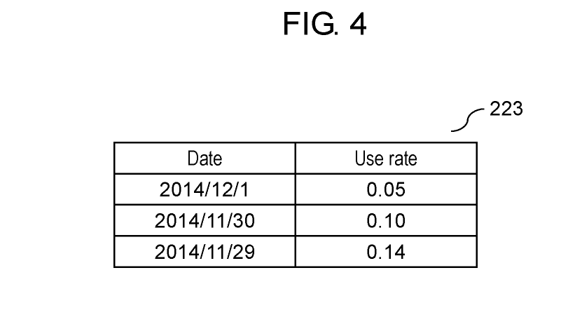

FIG. 4 is a diagram showing an example of use rate table 223. As shown in FIG. 4, use rate table 223 is constructed by the date and the use rate. As shown in FIG. 4, the use rate on the date “2014/12/1” is “0.05”. The use rate on the date “2014/11/30” is “0.10”. The use rate on the date “2014/11/29” is “0.14”. As shown in FIG. 4, the use rate stored in use rate table 223 should be stored in a prescribed time span, e.g., for three days. Further, it is also possible to store the use rate of only the day when the application is used in the prescribed time span.

Note that, use rate table 223 may additionally define other item. For example, in place of the date, more detailed time division may be additionally used.

Returning back to the description of FIG. 1, CPU 210 selects a topic to present to the user from topic table 221, and stores a history of the selected topic in conversation history table 222. Further, CPU 210 calculates the use rate of the interactive application, and stores the use rate in use rate table 223. Still further, CPU 210 updates the weight of the topic using the use rate of a prescribed time span stored in use rate table 223. Details of the weight update of a topic will be described later.

Communication I/F 230 is a communication interface that communicates with client 100 via communication network 300.

### [1-1-3. Configuration of Client]

Next, a configuration of client 100 will be described. In FIG. 1, client 100 includes CPU 110, memory 120, communication I/F 130, input unit 140, and display unit 150. Client 100 may be a terminal dedicated to the user, or may be a terminal shared by a plurality of users. When the terminal is shared by a plurality of users, using the user management of the operation system or the like, management for each user should be realized.

Memory 120 includes use time table 121. Use time table 121 stores the time during which the user uses client 100.

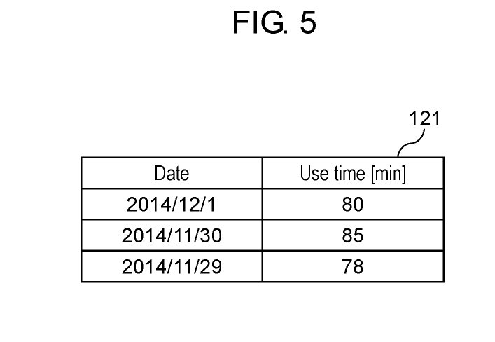

FIG. 5 is a diagram showing an example of use time table 121.

As shown in FIG. 5, use time table 121 is constructed by the date and the use time. Use time table 121 stores the total use time on a daily basis as the use time. For example, a time that the backlight is ON, or an operating time for the OS (Operating System) of client 100 and the like are also regarded as the use time. The use time on the date “2014/12/1” is “80 minutes”. The use time on the date “2014/11/30” is “85 minutes”. The use time on the date “2014/11/29” is “78 minutes”.

Note that, when client 100 is shared by a plurality of users, IDs that uniquely identify the users may be additionally defined in use time table 121. Further, use time table 121 may be provided for each user.

CPU 110 runs the OS and the interactive application. CPU 110 transmits, to server 200, a request for a topic, an answer for the topic, and the use time. Further, CPU 110 displays topic information received from server 200 on display unit 150. CPU 110 transmits, to server 200, a user's answer input from input unit 140. Further, when CPU 110 receives a message from server 200, CPU 110 displays the message on display unit 150.

Communication I/F 130 is a communication interface for communicating with server 200 via communication network 300.

Display unit 150 displays topic information, a message to the user and the like.

Input unit 140 are input a user's answer to a topic and the like.

### [1-2. Operation]

The operation of conversation processing system 500 constructed as described above will be described below.

### [1-2-1. Conversation Process]

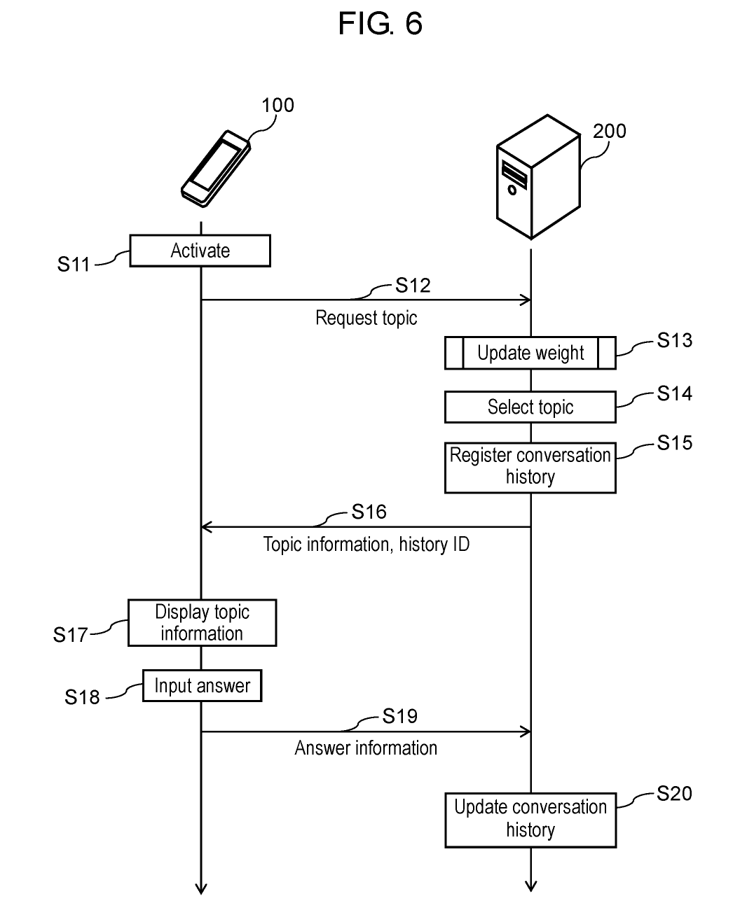

FIG. 6 is a time chart for describing conversation processes of conversation processing system 500.

(Step S11) Firstly, with respect to client 100, the user operates input unit 140 and activate the interactive application.

(Step S12) CPU 110 of client 100 requests a topic from server 200 via communication I/F 130.

(Step S13) When CPU 210 of server 200 receives the request for a topic from client 100 via communication I/F 230, CPU 210 updates the weight of the topic defined in topic table 221 of memory 220. Details of updating the weight of a topic will be described later.

(Step S14) CPU 210 selects one conversation ID from topic table 221. CPU 210 selects the conversation ID based on weight set for each conversation ID in topic table 221. For example, CPU 210 may select the conversation ID at random according to the selection probability based on the weight. Further, CPU 210 may select the conversation ID with the greatest weight.

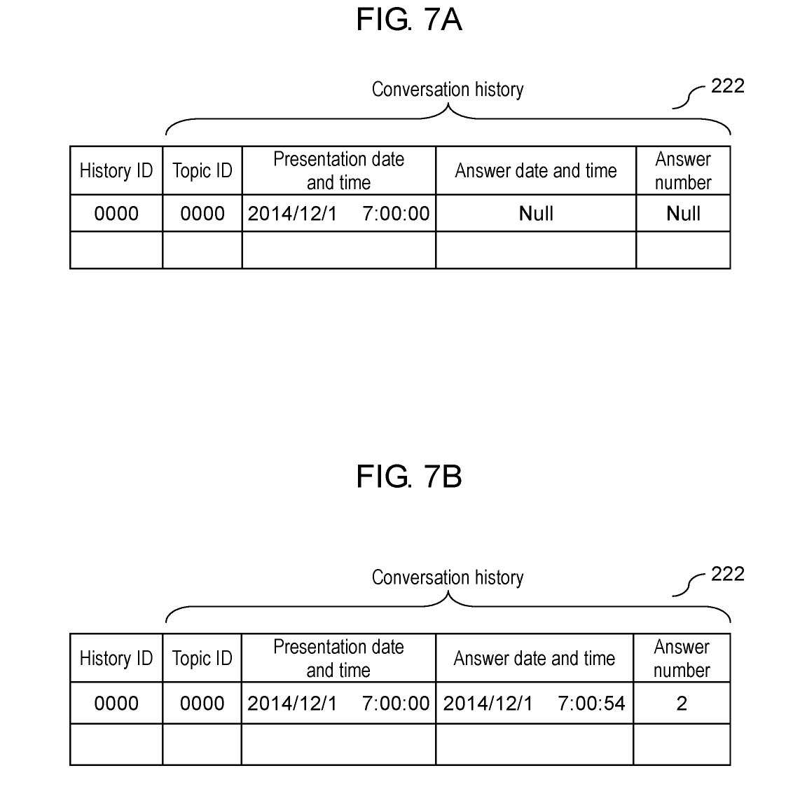

(Step S15) CPU 210 registers the selected conversation ID and its presentation date and time in conversation history table 222 as a new conversation history. For example, FIG. 7A shows conversation history table 222 in the case where the selected conversation ID is “0000” and the presentation date and time is “2014/12/1 7:00:00”. In FIG. 7A, the conversation ID “0000” and the presentation time “2014/12/1 7:00:00” are stored in association with the history ID “0000”. At this time point, since the answer date and time and the answer number are not determined, Null is stored for the answer date and time and answer number.

(Step S16) CPU 210 transmits, to client 100, the topic information and the history ID corresponding to the selected conversation ID via communication I/F 230. With the conversation ID “0000”, the topic information is the topic “What will you eat lunch?” and the answer candidates “1. A bowl of rice, 2. Noodles, 3. Others”, and the history ID is “0000”, and therefore CPU 210 transmits these topic information and history ID.

(Step S17) When CPU 110 of client 100 receives the topic information and the history ID from server 200, CPU 110 displays them on display unit 150.

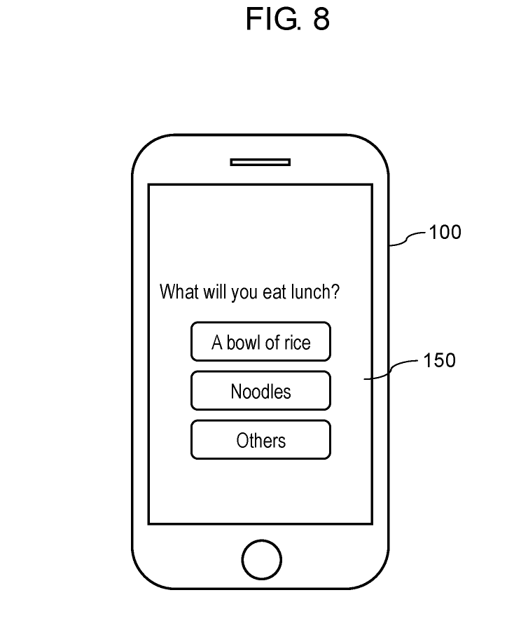

FIG. 8 is a diagram showing an example of displaying the topic on display unit 150 of client 100. As shown in FIG. 8, on display unit 150 of client 100, the topic “What will you eat lunch?” and the answer candidates “A bowl of rice”, “Noodles”, and “Others” are displayed.

(Step S18) The user selects one answer among the answer candidates displayed on display unit 150 with input unit 140. It is assumed that the selected answer is “Noodles”.

(Step S19) Since “Noodles” is selected with input unit 140, CPU 110 transmits to server 200 via communication I/F 130, the answer number “2” corresponding to “Noodles”, i.e., the history ID “0000”, the answer number “2”, and the answer date and time as the answer information. It is assumed that the answer date and time is “2014/12/1 7:00:54”.

(Step S20) When CPU 210 receives the answer information from client 100 via communication I/F 230, CPU 210 updates, in conversation history table 222, a conversation history including a history ID which corresponds to the history ID contained in the answer information. FIG. 7B shows conversation history table 222 in the case where conversation history table 222 shown in FIG. 7A is updated. CPU 210 searches for the conversation history of the history ID “0000”. CPU 210 stores the answer date and time and the answer number in the conversation history of the history ID “0000”. In the history ID “0000” shown in FIG. 7B, the answer date and time “2014/12/1 7:00:54” and the answer number “2” are stored.

The processes of Steps S12 to S20 are repeated until the user operates input unit 140 of client 100 and thereby ends the interactive application.

### [1-2-2. Calculation of Use Rate]

CPU 110 of client 100 transmits the date and the use time in use time table 121 every predetermined time to server 200. As the date and the use time, for example, in use time table 121 shown in FIG. 5, the use time on the date “2014/12/1” is “80 minutes”.

CPU 210 of server 200 calculates the sum of differences between the presentation time and the answer time in conversation history table 222, and divides the sum by the use time received from client 100. Thus, CPU 210 obtains the use rate per day for the interactive application. In conversation history table 222 shown in FIG. 3, the history of “2014/12/1” is the history IDs “0000” and “0001”. The difference between the answer date and time and the presentation date and time of the history ID “0000” is “54 seconds”, and the difference between the answer date and time and the presentation date and time of the history ID “0001” is “3 minutes 6 seconds”. The sum of the differences is “4 minutes”. Since the use time received from client 100 is “80 minutes”, the use rate is “0.05”. CPU 210 stores the use rate “0.05” in use rate table 223, as shown in FIG. 4.

### [1-2-3. Updating Weight]

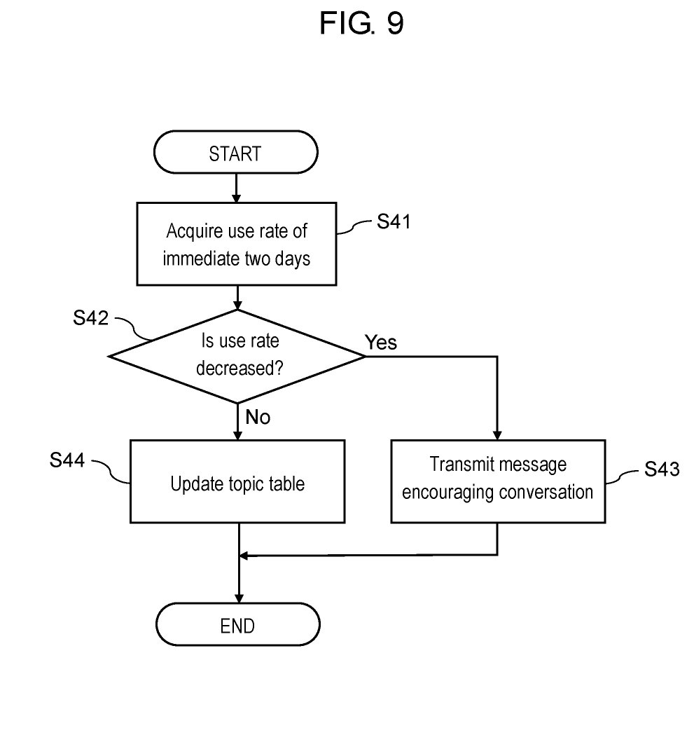

Next, updating a weight in topic table 221 in Step 13 in FIG. 6 will be described in detail. FIG. 9 is a flowchart for updating a weight in topic table 221. Updating a weight is performed for reflecting the user's result of answer to a topic.

(Step S41) CPU 210 acquires the use rate of the immediate two days stored in use rate table 223. For example, CPU 210 acquires the use rate of “2014/12/1” and “2014/11/30”.

Note that, the use rate to acquire is not limited to that of the immediate two days. In place of the use rate of the immediate two days, the use rate of another time span may be used. Alternatively, the use rate that is arithmetically processed, such as the use rate averaged for a prescribed time span, may be used.

(Step S42) CPU 210 determines whether the acquired use rate is decreased. When CPU 210 determines that the acquired use rate is decreased (when Yes), the control proceeds to Step S43. For example, as shown in FIG. 4, in use rate table 223, the use rate on the date “2014/12/1” is “0.05”, and the use rate on the date “2014/11/30” is “0.10”. The use rate is decreased from “0.10” to “0.05”. When CPU 210 determines that the acquired use rate is not decreased (when No), the control proceeds to Step S44.

(Step S43) CPU 210 transmits, via communication I/F 230, any push-based message of encouraging conversation to client 100. A decreasing of the use rate suggests that the user is getting bored with the interactive application, and the use willingness is decreased. Accordingly, transmission of the message is performed in order to encourage the user to use the interactive application. When CPU 110 of client 100 receives the message from server 200, CPU 110 displays the message on display unit 150.

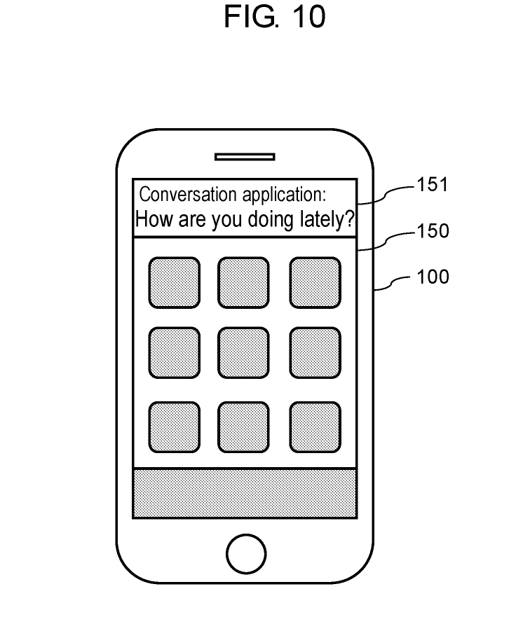

FIG. 10 is a diagram showing an example of displaying a message of encouraging conversation on client 100. As shown in FIG. 10, on display unit 150 of client 100, message 151 encouraging use of the interactive application “How are you doing lately?” is displayed.

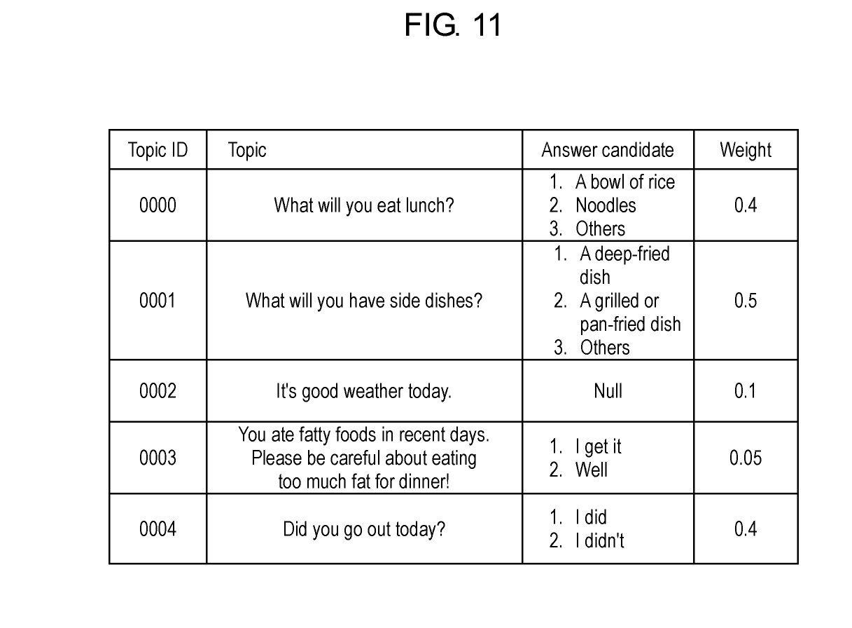

(Step S44) When CPU 210 determines that the acquired use rate is not decreased, CPU 210 updates the weight in topic table 221. CPU 210 updates to decrease the weight of the topic whose answer date and time is Null in conversation history table 222. The topic with no answer is determined to be the topic that is highly possibly the user did not like. Therefore, the weight is changed such that another topic is preferentially selected. For example, in conversation history table 222 shown in FIG. 3, with the conversation ID “0003” of the history ID “0003”, the answer date and time is Null. Therefore, the weight of the conversation ID “0003” in topic table 221 shown in FIG. 2 is changed from “0.1” to “0.05”. FIG. 11 is topic table 221 after the weight of the conversation ID “0003” in topic table 221 shown in FIG. 2 is changed. In FIG. 11, the weight of the conversation ID “0003” is changed to “0.05”.

Note that, CPU 210 may return the updated weight to the original weight in accordance with a lapse of time. For example, the weight may be gradually returned from 0.05 to 0.1 within 24 hours. This is because the user may again like the topic that the user once did not like, after a lapse of time.

Note that, the time of changing the weight is not limited to 24 hours. Further, after a lapse of a prescribe time, the weight may be returned to the weight before updating. Similarly, as to the conversation ID with an increased weight also, the weight may be returned to the original weight. This is because the user may lose interest in the topic that the user once liked, in accordance with a lapse of time. In this manner, the weight to the conversation ID is dependence on time.

Note that, updating a weight may be performed not only with the topic whose answer date and time is Null in conversation history table 222, but also to the answered topic. For example, among the answered topics, the topic that took long time from the presentation to the answer is determined to be highly possibly the topic that the user does not like, and the weight may be updated such that another topic is preferentially selected.

### [1-3. Effect and Others]

As described above, the conversation processing method according to the present exemplary embodiment is a conversation processing method executed in an interactive application with which a user interacts, on an electronic device. The method includes: selecting, in a topic table storing a plurality of sets of topic information and a weight of the topic information, the topic information based on the weight and presenting the selected topic information to the user; storing a conversation history which associates with the selected topic information, presentation date and time, an answer of the user to the selected topic information and answer date and time, in a conversation history table; calculating a use rate of a use time of the interactive application relative to a use time of the electronic device based on the conversation history table; and notifying of encouraging use of the interactive application when the use rate is decreased, and updating the weight of the topic information without the answer of the user in the conversation history table when the use rate is not decreased.

Further, in the conversation processing method according to the present exemplary embodiment, updating the weight based on the answer of the user in the conversation history table when the use rate is not decreased.

Thus, when the use rate of the interactive application by the user decreases, the user is encouraged to use the interactive application, the weight is updated in accordance with the answer history to the topic, and for example the probability of selecting the topic that was not answered by the user can be decreased. Further, in accordance with the degree of interest of the user in topics, a topic can be selected. Accordingly, with the interactive application, continuous conversation with the user is facilitated.

Further, in the conversation processing method according to the present exemplary embodiment, the method includes restoring the updated weight after a lapse of a prescribed time. Still further, in the conversation processing method according to the present exemplary embodiment, the method includes restoring the updated weight gradually within a prescribed time.

Thus, the updated weight can be returned to the original weight. Accordingly, the original weight can be recovered from temporary fluctuations in user preferences to topics.

### Other Exemplary Embodiments

As described above, as the illustration of the technique of the present disclosure, the first exemplary embodiment has been described. However, the technique of the present disclosure is not limited thereto, and applicable also to an exemplary embodiment to which modification, replacement, addition, omission and the like are made. Further, it is also possible to form a new exemplary embodiment by combining the constituent elements described in the first exemplary embodiment.

Therefore, in the following, other exemplary embodiments are exemplarily shown.

In the first exemplary embodiment, as the example of construct for realizing the conversation processing method, conversation processing system 500 constructed by client 100 and server 200 has been described. However, the present disclosure is not limited thereto. For example, a part of functions of server 200 or whole functions of server 200 may be implemented in client 100. Using a single dedicated apparatus that executes all the processes, a conversation can be realized offline.

Note that, when client 100 and server 200 are used, distributed processing is possible.

Further, in the first exemplary embodiment, the notification to the user is carried out by a push-based message. However, the notification may be carried out by other procedures such as e-mail.

Still further, as communication network 300, the Internet line network is used. However, the present disclosure is not limited thereto, and wireless communication or the like may be used.

Still further, the present disclosure can be realized not only as the conversation processing system and the conversation processing method. Out of the processes included in the conversation processing method, the processes executed in client 100 may be realized as a program executed by a processor of client 100, and the processes executed in server 200 may be realized as a program executed by a processor of client 100. Alternatively, the present disclosure can be realized as a computer readable recording medium storing the programs.

Note that, since the exemplary embodiments described above are intended to illustrate the technique of the present disclosure, various modifications, replacement, addition, omission and the like can be made within the scope of claims or within the scope equivalent thereto.

What is claimed is:

1. A conversation processing method executed in an interactive application with which a user interacts, on an electronic device, the method comprising:
selecting, in a topic table storing a plurality of sets of topic information and a weight of the topic information, the topic information based on the weight and presenting the selected topic information to the user;
storing a conversation history which associates with the selected topic information, presentation date and time, an answer of the user to the selected topic information and answer date and time, in a conversation history table;
calculating a use rate of a use time of the interactive application relative to a use time of the electronic device based on the conversation history table; and
notifying of encouraging use of the interactive application when the use rate is decreased, and updating the weight of the topic information without the answer of the user in the conversation history table when the use rate is not decreased.

2. The conversation processing method according to claim 1, wherein
updating the weight based on the answer of the user in the conversation history table when the use rate is not decreased.

3. The conversation processing method according to claim 1, wherein
restoring the updated weight after a lapse of a prescribed time.

4. The conversation processing method according to claim 1, wherein
restoring the updated weight gradually within a prescribed time.

5. The conversation processing method according to claim 1, wherein
calculating the use time of the interactive application based on the conversation history during a prescribed period in the conversation history table, and calculating a use rate of the use time of the interactive application relative to a use time of the electronic device during the prescribed period.

6. A conversation processing system comprising:
an electronic device executed an interactive application with which a user interacts; and
a server connected to the electronic device via a communication network,
wherein
the server includes:
a memory configured to store a topic table storing a plurality of sets of topic information and a weight of the topic information, a conversation history table storing a conversation history which associates with the topic information transmitted to the electronic device and presentation date and time, and an answer transmitted from the electronic device and answer date and time, and a use rate table storing a use rate of a use time of the interactive application relative to a use time of the electronic device; and
a controller configured to calculate the use rate based on the use time transmitted from the electronic device and the conversation history table, store the use rate in the use rate table, transmit a notification of encouraging use of the interactive application relative to the electronic device when the use rate is decreased, and update the weight based on the conversation history table when the use rate is not decreased, and
the electronic device includes:
a display unit configured to display the topic information and the notification received from the server;
an input unit configured to input an answer to the topic information by the user; and
a controller configured to transmit the use time to the server every prescribed period.

7. An electronic device installed an interactive application with which a user interacts, the electronic device comprising:
a display unit configured to select topic information among a plurality of topic information and displaying the selected topic information; and
an input unit configured to input an answer to the topic information by the user,
wherein
the display unit displays a notification of encouraging use of the interactive application when a use rate of a use time of the interactive application relative to a use time of the electronic device is decreased and
a weight to the topic information is updated when the use rate is not decreased.

8. A conversation processing apparatus connected to, via a communication network, an electronic device installed an interactive application with which a user interacts, the conversation processing apparatus comprising:
a memory configured to store a topic table storing a plurality of sets of topic information and a weight of the topic information, a conversation history table storing a conversation history which associates with the topic information transmitted to the electronic device and presentation date and time, and an answer transmitted from the electronic device and answer date and time, and a use rate table storing a use rate of a use time of the interactive application relative to a use time of the electronic device; and
a controller configured to calculate the use rate based on the use time transmitted from the electronic device and the conversation history table, store the use rate in the use rate table, transmit a notification of encouraging use of the interactive application relative to the electronic device when the use rate is decreased, and update the weight based on the conversation history table when the use rate is not decreased.
